(19) United States
(12) Patent Application Publication
(10) Pub. No.: US 2003/0177945 A1
(43) Pub. Date: Sep. 25, 2003

(54) Ink composition for ink-jet textile printing

(75) Inventors: Chuan-hsi Li, Taoyuan Hsien (TW); Chien-wen Li, Taipei Hsien (TW); Hong-Chang Huang, Taipei City (TW)

Correspondence Address: BACON & THOMAS, PLLC, 625 SLATERS LANE, FOURTH FLOOR, ALEXANDRIA, VA, 22314

(73) Assignee: Everlight USA, Inc.,, Pineville, NC

(21) Appl. No.: 10/138,648

(22) Filed: May 6, 2002

(30) Foreign Application Priority Data
Mar. 15, 2002 (TW) 91104908

(51) Int. Cl. C09D 11/00

(52) U.S. Cl. 106/31.58; 106/31.59

(57) ABSTRACT

Disclosed herein is an ink composition for ink-jet textile printing, which primarily includes (a) at least a reactive dye, (b) water, and (c) at least an organic solvent that is a C₄-C₆ polyhydric alcohol having one or less primary alcohol groups. The ink composition of the present invention is suitable for dyeing and printing of materials containing either cellulose fibers such as cotton, synthetic cotton, hemp, and synthetic hemp, or amide fibers such as wool and nylon.

### BACKGROUND OF THE INVENTION

1. Field of the Invention

The present invention relates to an ink composition for ink-jet textile printing, and particularly to an ink composition for ink-jet textile printing suitable for dyeing and printing of materials containing cellulose fibers.

2. Related Prior Art

Textile printing is one of the most popular technologies in the textile industry, since no halftone is necessary cost and processing time can be reduced, even though versatile patterns are desired.

For textile printing, required ink composition properties are viscosity, stability, surface tension and mobility. Furthermore, the printed fabrics should have high-quality colour strength, fixation, fiber-dye bond stability, and wet fastness.

In general, the dyes or pigments can be dissolved or dispersed in water or liquid containing water-soluble solvents. Proper surfactants can be added to the ink compositions to modify characteristics thereof.

U.S. Pat. No. 5,603,756 disclosed an ink composition including at least a reactive dye, polyhydric alcohol and water, which further includes a reaction product of the reactive dye with polyhydric alcohol. The polyhydric alcohol used here partially modifies the reactive dyes, however, the colour strength and fixation of the ink composition on fabrics are not satisfying.

U.S. Pat. No. 6,015,454 disclosed another ink composition including at least a reactive dye and 1,2-propylene glycol or N-methyl-2-pyrrolidone, which improved colour strength and fixation. Unfortunately, properties of the ink compositions, such as storage stability, clogging in nozzles and long-term printing stability are not satisfying.

Accordingly, the present invention provides alternative ink compositions in which specific solvents are added.

### SUMMARY OF THE INVENTION

An object of the present invention is to provide an ink composition for ink-jet textile printing, which is suitable for dyeing and printing material containing cellulose or other fibers.

Accordingly, the ink composition of the present invention essentially comprises (a) at least a reactive dye, (b) water, and (c) at least an organic solvent which is a C₄-C₆ polyhydric alcohol having one or less primary alcohol groups. The ink composition of the present invention is suitable for ink-jet printers, for example, piezoelectric ink-jet printers and thermobubble ink-jet printers.

### DETAILED DESCRIPTION OF THE PREDERRED EMBODIMENTS

An ink composition for ink-jet textile printing of the present invention essentially comprises (a) at least a reactive dye, (b) water, and (c) at least an organic solvent which is a C₄-C₆ polyhydric alcohol having one or less primary alcohol groups.

For the above mentioned organic solvent, the C₄-C₆ polyhydric alcohol having no primary alcohol group can be 2,3-dimethyl-2,3-butanediol, 2,3-butanediol, 2,4-pentanediol, 2,5-hexanediol, or hexylene glycol; and the C₄-C₆ polyhydric alcohol having one primary alcohol group can be 2-methyl-1,2-propanediol, 1,2-butanediol, 1,3-butanediol, 1,2-pentanediol, 1,2-hexanediol, or hexane-1,3,5-triol. Further, the organic solvent can be mixtured of these polyhydric alcohols, for example, a mixture of hexylene glycol and 1,3-butanediol.

The above mentioned reactive dye is water-soluble and has a monochlorotriazinyl derivative group, a β-sulfatoethylsulfone derivative group or a vinylsulfone derivative group. Such reactive dyes can be selected from the Color Index, for example, C.I. Reactive Red 3:1, C.I. Reactive Red 23, C.I. Reactive Red 31, C.I. Reactive Red 33, C.I. Reactive Red 24, C.I. Reactive Yellow 2, C.I. Reactive Yellow 18, C.I. Reactive Yellow 80, C.I. Reactive Yellow 95, C.I. Reactive Blue 15, C.I. Reactive Blue 5, C.I. Reactive Blue 49, C.I. Reactive Blue 71, C.I. Reactive Blue 176, C.I. Reactive Orange 12, C.I. Reactive Orange 13, C.I. Reactive Black 8 or C.I. Reactive Black 5.

The reactive dyes can be used individually or mixed with each other, or associated with salts of an alkali metal or ammonium thereof. Preferably, the added salt is less than 0.5 wt %. The salts produced during processes and diluents can be removed by membrane separation, ultra-filtration, reverse osmosis, or dialysis.

In general, the ink composition includes 5-35 wt % of the reactive dye, 35-94.9 wt % of water, and 0.1-30 wt % of the organic solvent, based on the total weight of the ink composition.

Preferably, the ink composition includes 10-30 wt % of the reactive dye, 50-89 wt % of water, and 1-20 wt % of the organic solvent.

The organic solvent is usually added at 0.1-30 wt %, preferably between 1-20 wt %, depending on conditions such as wetness of nozzles, stability of printing and storage.

The ink composition of the present invention can further include (d) a non-ionic surfactant, for example, an acetylene glycol derivative of the following formula (II),

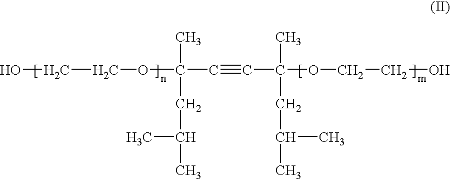

wherein the sum of n and m is an integer ranging from 0 to 50, and preferably from 0 to 20. The commercial production includes Surfynol 465, Surfynol 485, Surfynol 420, and Surfynol 104. (Air Products & Chemicals, Inc.). The A surfactant is usually added at 0.1-3 wt %, and preferably at 0.1-1 wt %.

The ink composition of the present invention can further include (e) a buffer, whereby the solution can be at pH 4-9, wherein pH 4-8 is preferred, and preferably pH 5-7. The buffer can be acetic acid, acetate, phosphoric acid, phosphate, borax, borate and citrate, for example, acetic acid, sodium acetate, phosphoric acid, sodium phosphate, borax, sodium borate, sodium tetraborate and sodium citrate. The buffer is usually added at 0.1-3 wt %, and preferably at 0.1 -1 wt %, based on the total weight of the ink composition.

The ink composition of the present invention can further optionally include (f) a microbicide or an additive, for example, a defoamer. The microbicide is preferably added at 0.01-1 wt %. The additive can be NUOSEPT (Nudex Inc., a division of Huls Americal), UCARCIDE (Union Carbide), VANCIDE (RT Vanderbilt Co.) and PROXEL (ICI Americas). The additive is usually added at 0.01-1 wt % based on the total weight of the ink composition.

The ink composition of the present invention can be prepared by mixing the above components in water according to general procedures.

The ink composition of the present invention can be applied to printing on material containing cellulose fibers such as cotton, hemp, cellulose, synthetic fibers, and materials containing hydroxyl fibers.

The ink composition of the present invention can be fixed on the fibers by ink-jet printing, and particularly by piezoelectric or thermobubble ink-jet printers.

The ink composition of the present invention can provide excellent colour strength, fixation, storage stability, no clogging in nozzles, and stability for long-term printing.

According to the ink compositions of the present invention, the printed fabrics have high-quality properties such as strong fiber-dye bond stability in both the acidic and the alkaline solution, clear features and good colour strength, and good fastness to light and wet conditions, for example, washing, water, brine, re-dyeing, moisture, chlorinating, rubbing, hot pressing and pleating.

The following examples are used to illustrate the present invention, but not limited to the scope thereof. In these examples, parts and % are counted by weight, relationship between % weight and % volume is the same as kilograms and liters, and the temperature is in degrees Celsius.

### EXAMPLE 1

15.4 parts of C.I. Reactive Yellow 80, 5 parts of hexylene glycol, 0.5 parts of non-ionic surfactant SURFYNOLS 465, 1 part of microbial reagent Proxel x12, and 78.1 parts of water are mixed well to obtain an ink composition.

### EXAMPLES 2-12 AND COMPARATIVE EXAMPLES 1-6

Repeat the procedure of Example 1, but the components are added at different amount according to Table 1 and Table 2.

| | | Organic | | Microbial | |
|---|---|---|---|---|---|
| Exam- | Dye | Solvent | Surfactant | Reagent | Water |
| ple | (wt %) | (wt %) | (wt %) | (wt %) | (wt %) |
| Exam- | C.I. Reactive | 1,3- | Surfynols | Proxel | Water |
| ple 2 | Yellow 80 | butanediol | 465 | x12 | (78.1 wt %) |
| | (15.4 wt %) | (5 wt %) | (0.5 wt %) | (1 wt %) | |
| Exam- | C.I. Reactive | hexylene | Surfynols | Proxel | Water |
| ple 3 | Red 31 | glycol | 465 | x12 | (68.5 wt %) |
| | (25 wt %) | (5 wt %) | (0.5 wt %) | (1 wt %) | |
| Exam- | C.I. Reactive | 1,3- | Surfynols | Proxel | Water |
| ple 4 | Red 31 | butanediol | 465 | x12 | (68.5 wt %) |
| | (25 wt %) | (5 wt %) | (0.5 wt %) | (1 wt %) | |
| Exam- | C.I. Reactive | hexylene | Surfynols | Proxel | Water |
| ple 5 | Blue 15 | glycol | 465 | x12 | (68.3 wt %) |
| | (25.2 wt %) | (5 wt %) | (0.5 wt %) | (1 wt %) | |
| Exam- | C.I. Reactive | 1,3- | Surfynols | Proxel | Water |
| ple 6 | Blue 15 | butanediol | 465 | x12 | (68.3 wt %) |
| | (25.2 wt %) | (5 wt %) | (0.5 wt %) | (1 wt %) | |
| Exam- | Reactive | hexylene | Surfynols | Proxel | Water |
| ple 7 | Black P-2R | glycol | 465 | x12 | (79.5 wt %) |
| | (14 wt %) | (5 wt %) | (0.5 wt %) | (1 wt %) | |
| Exam- | Reactive | 1,3- | Surfynols | Proxel | Water |
| ple 8 | Black P-2R | butanediol | 465 | x12 | (79.5 wt %) |
| | (14 wt %) | (5 wt %) | (0.5 wt %) | (1 wt %) | |
| Exam- | Reactive | hexylene | Surfynols | Proxel | Water |
| ple 9 | Black P-2R | glycol | 465 | x12 | (79.5 wt %) |
| | (14 wt %) | (2.5 wt %) | (0.5 wt %) | (1 wt %) | |
| | | 1,3- | | | |
| | | butanediol | | | |
| | | (2.5 wt %) | | | |
| Exam- | C.I. Reactive | hexylene | Surfynols | Proxel | Water |
| ple 10 | Black 5 | glycol | 465 | x12 | (79.5 wt %) |
| | (14 wt %) | (2.5 wt %) | (0.5 wt %) | (1 wt %) | |
| | | 1,3- | | | |
| | | butanediol | | | |
| | | (2.5 wt %) | | | |
| Exam- | C.I. Reactive | hexylene | — | Proxel | Water |
| ple 11 | Blue 49 | glycol | x12 | (74 wt %) | |
| | (10 wt %) | (15 wt %) | | (1 wt %) | |
| Exam- | C.I. Reactive | 1,3- | — | Proxel | Water |
| ple 12 | Blue 49 | butanediol | | x12 | (74 wt %) |
| | (10 wt %) | (15 wt %) | | (1 wt %) | |

| Compara- | | Organic | | Microbial | |
|---|---|---|---|---|---|
| tive | Dye | Solvent | Surfactant | Reagent | Water |
| Example | (wt %) | (wt %) | (wt %) | (wt %) | (wt %) |
| Compara- | C.I. Reactive | Diethylene | — | Proxel x12 | Water |
| tive | Blue 49 | Glycol | | (1 wt %) | (74 wt |
| Example 1 | (10 wt %) | (15 wt %) | | | %) |
| Compara- | C.I. Reactive | Glycerol | — | Proxel x12 | Water |
| tive | Blue 49 | (15 wt %) | | (1 wt %) | (74 wt |
| Example 2 | (10 wt %) | | | | %) |
| Compara- | C.I. Reactive | Dipropylene | Surfynols | Proxel x12 | Water |
| tive | Blue 49 | glycol | 465 | (1 wt %) | (74 wt |
| Example 3 | (10 wt %) | (15 wt %) | (0.5 wt %) | | %) |
| Compara- | C.I. Reactive | Polyethylene | — | Proxel x12 | Water |
| tive | Blue 49 | glycol 400 | | (1 wt %) | (74 wt |
| Example 4 | (10 wt %) | (15 wt %) | | | %) |
| Compara- | C.I. Reactive | 1,2,6-hexane | — | Proxel x12 | Water |
| tive | Blue 49 | triol | | (1 wt %) | (74 wt |
| Example 5 | (10 wt %) | (15 wt %) | | | %) |
| Compara- | C.I. Reactive | Triethylene | — | Proxel x12 | Water |
| tive | Blue 49 | Glycol | | (1 wt %) | (74 wt |
| Example 6 | (10 wt %) | (15 wt %) | | | %) |

### COMPARATIVE EXAMPLE 7

(Conventional Screen Printing)

100 parts of urea, 10 parts of reduction inhibitor agent, 20 parts of sodium bicarbonate, 60 parts of sodium alginate and 810 parts of warm water, in a sum of 1000 parts, are mixed to obtain an assisting paste. 3 parts of C.I. Reactive Blue 49 is spread on 97 parts of the assisting paste and then rapidly stirred. A twill halftone of 45 degrees and 100 meshes goes over a mercerized cotton twill, on which the color paste is then brushed. The fabric is then dried in an oven at 65° C. for 5 min. The dried fabric is then steamed with 102-105° C. saturated steam in a steamer at normal pressure for 10 min. Finally, the dyed fabric is washed with cold water, boiling water for 10 min, boiling non-ionic detergent for 10 min, and cold water, and then dried.

### COMPARATIVE EXAMPLES 8-11

Repeat the procedure of Comparative Example 7, but the C.I. Reactive Blue 49 is replaced with the following dyes.

| Comparative Example | Dye |
|---|---|
| Comparative Example 8 | C.I. Reactive Yellow 80 |
| Comparative Example 9 | C.I. Reactive Red 31 |
| Comparative Example 10 | C.I. Reactive Blue 15 |
| Comparative Example 11 | Reactive Black P-2R |

Printing Test

1. Pre-treating Exhausting Fabrics

100 parts of urea, 10 parts of reduction inhibitor agent, 20 parts of sodium bicarbonate, 60 parts of sodium alginate, and 810 parts of warm water, in a sum of 1000 parts, are mixed to obtain the pre-treating solution. 3/1 twill fabrics including natural cellulose fibers, cotton, and regenerated fibers, such as rayon, are used in the test. Before printed, the fabrics are dipped in the pre-treating solution (pick-up 70%) by pressing under a roller and then dried with hot air at 100° C.

2. Printing, Fixing and Post-Treating

A thermobubble printer (HP 870C) and a piezoelectric printer (EPSON COLOR 460) are provided for printing. The ink compositions obtained from Examples 1-10 are first applied to the above printers and then printed on the above fabrics. After drying at 50° C. for 2 min, these fabrics are brought to fixation in 102-110° C. steam for 8-15 min. Finally, the fabrics are washed with 100° C. water and water containing detergent in sequence, and then dried.

The test results are listed in Table 3.

TABLE 3

| | | | Stability of Storage | |
|---|---|---|---|---|
| | | Stability | High | Low |
| | Bleed- | of | Temperature | Temperature |
| Example | ing | Printing | (50° C., 3 days) | (−5° C., 3 days) |
| Example 1(Y) | Good | Good | Good | Good |
| Example 2(Y) | Good | Good | Good | Good |
| Example 3(M) | Good | Good | Good | Good |
| Example 4(M) | Good | Good | Good | Good |
| Example 5(C) | Good | Good | Good | Good |
| Example 6(C) | Good | Good | Good | Good |
| Example 7(K) | Good | Good | Good | Good |
| Example 8(K) | Good | Good | Good | Good |
| Example 9 | Good | Good | Good | Good |
| Example 10 | Good | Good | Good | Good |

1. Bleeding: Observing whether the single ink composition printed on one block leaks outside the edges thereof or two different ink compositions printed on two adjacent blocks leak to each other.

Good: no bleeding

No Good: bleeding

2. Printing Stability: Observing whether the ink composition gives a continuous flow.

Good: 0-1 nozzles are clogged

Average: 2-3 nozzles are clogged

No Good: 4 or more nozzles are clogged

3. Low Temperature Storage Stability: Observing for substance separation in the ink compositions (50c.c.) after 3 days of buildup at 0-5° C.

Good: no substance separation

No Good: substance separation

4. High Temperature Storage Stability: Using a dip dyeing bath, Observing whether the colour strength fade of the ink compositions (50c.c.) after 3 days of storage at 50° C.

Good: 0-5% fading

Average: 5-10% fading

No Good: more than 10% fading

In the above printing test, Examples 1, 3, 5 and 7 include a solvent different from Examples 2, 4, 6 and 8; and Examples 9 and 10 include various dyes and solvent mixtures. As shown in Table 3, the ink compositions according to the present invention can provide good properties such as no bleeding, and good stability of printing and storage.

The ink compositions of Examples 11 and 12 and Comparative Examples 1-6 are printed on fabrics according to the above procedures, and then washed and dried. Fixation rate of these compositions are listed in Table 4.

The fixation rate is measured according to ABS values of the ink compositions extracted from the fabric before and after fixing, wherein the ABS values are obtained from the UV spectrum.

A₀=ABS of the ink extracted from the fabric (4 cm×5 cm) before fixing

A₁=ABS of the ink extracted from the fabric (4 cm×5 cm) after fixing

Fixing rate=(1−A₁/A₀)

TABLE 4

| | | Fixing | |
|---|---|---|---|
| Sample | Organic Solvent | Rate | Grade |
| Comparative Example 1 | Diethylene Glycol | 45% | No Good |
| Comparative Example 2 | Glycerol | 40% | No Good |
| Comparative Example 3 | Dipropylene glycol | 52% | Worse |
| Comparative Example 4 | Polyethylene glycol 400 | 30% | No Good |
| Comparative Example 5 | 1,2,6-hexanetriol | 25% | No Good |
| Comparative Example 6 | Triethylene Glycol | 32% | No Good |
| Comparative Example 7 | — | 60% | Similar |
| Example 11 | Hexylene glycol | 60% | Similar |
| Example 12 | 1,3-butanediol | 60% | Similar |

1. The grades are obtained by comparing with the fixation rate of Comparative Example 7 (conventional screen printing).
Similar: lower by 0-2%
Worse: lower by 2-10%
No Good: lower by at least 10%

As shown in Table 4, the ink composition including novel components in accordance with the present invention can provide higher fixation rate to cotton material, when compared with the conventional ink compositions including usual solvents.

Table 5 indicates fixation rate and fastness of the ink compositions obtained from Examples 1-8 and Comparative Examples 8-11 by applying to piezoelectric printing. Table 6 indicates different results thereof by applying to thermobubble printing.

TABLE 5

| | | Rubbing | | | |
|---|---|---|---|---|---|
| Example, | Fixation | Fastness | | Washing Fastness | |
| Comparative Example | rate | Dry | Wet | Nylon | Cotton |
| Example 1 | 82% | 5 | 3 | 5 | 4-5 |
| Example 2 | 82% | 5 | 3 | 5 | 4-5 |
| Comparative Example 8 | 75% | 5 | 3 | 5 | 4-5 |
| Example 3 | 59% | 4-5 | 2 | 5 | 4-5 |
| Example 4 | 59% | 4-5 | 2 | 5 | 4-5 |
| Comparative Example 9 | 55% | 4-5 | 2 | 5 | 4-5 |
| Example 5 | 40% | 4-5 | 2-3 | 5 | 3-4 |
| Example 6 | 41% | 4-5 | 2-3 | 5 | 3-4 |
| Comparative Example 10 | 37% | 4-5 | 2-3 | 5 | 3-4 |
| Example 7 | 71% | 4-5 | 2-3 | 5 | 4-5 |
| Example 8 | 70% | 4-5 | 2 | 5 | 4-5 |
| Comparative Example 11 | 62% | 4-5 | 2 | 5 | 4-5 |

1. The rubbing fastness is measured according to AATCC TEST METHOD 8-1988
2. The washing fastness is measured according to AATCC TEST METHOD 61-1989 3A

TABLE 6

| | | Rubbing | | | |
|---|---|---|---|---|---|
| Example, | Fixation | Fastness | | Washing Fastness | |
| Comparative Example | rate | Dry | Wet | Nylon | Cotton |
| Example 1 | 83% | 5 | 3 | 5 | 4-5 |
| Example 2 | 80% | 5 | 3 | 5 | 4-5 |
| Comparative Example 8 | 75% | 5 | 3 | 5 | 4-5 |
| Example 3 | 58% | 4-5 | 2-3 | 4-5 | 4-5 |
| Example 4 | 59% | 4-5 | 2-3 | 4-5 | 4-5 |
| Comparative Example 9 | 55% | 4-5 | 2-3 | 4-5 | 4-5 |
| Example 5 | 45% | 5 | 2-3 | 4-5 | 3-4 |
| Example 6 | 46% | 4-5 | 2-3 | 4-5 | 3-4 |
| Comparative Example 10 | 37% | 5 | 2-3 | 5 | 3-4 |
| Example 7 | 72% | 4-5 | 2-3 | 5 | 4-5 |
| Example 8 | 69% | 4-5 | 2-3 | 5 | 4-5 |
| Comparative Example 11 | 62% | 4-5 | 2-3 | 5 | 4-5 |

1. The rubbing fastness is measured according to AATCC TEST METHOD 8-1988
2. The washing fastness is measured according to AATCC TEST METHOD 61-1989 3A

In Tables 5 and 6, the ink compositions are sorted into four sets, i.e., Examples 1, 2 and Comparative Example 8, Examples 3, 4 and Comparative Example 9, Examples 5, 6 and Comparative Example 10, and Examples 7, 8 and Comparative Example 11. For each set, the dye is the same and other components are varied. The results indicate that the ink compositions of the present invention can provide higher fixation rate, similar rubbing fastness and washing fastness when compared with the conventional screen printing.

According to the above Examples and test results, the solvents used in the present invention are particularly suitable for the ink compositions of textile printing, and therefore properties including good colour strength, high fixation rate, good storage stability, no clogging in nozzles, and stable long-term printing can be achieved. Though the solvents used in the present invention have been mentioned in U.S. Pat. No. 5,603,756, the latter has different purposes and applications, i.e., paper printing. More important, not all solvents mentioned in U.S. Pat. No. 5,603,756 are suitable for textile printing. Table 4 shows that some of them are used in Comparative Examples 1-6 having poor fixation rate.

From the foregoing description, one skilled in the art can easily ascertain the essential characteristics of this invention, and without departing from the scope thereof, can make various changes and modifications of the invention to adapt it to various usages and conditions. Thus, other embodiments are also within the claims.

What is claimed is:

1. An ink composition for ink-jet textile printing, comprising
(a) at least a reactive dye;
(b) water; and
(c) at least an organic solvent which is a C₄-C₆ polyhydric alcohol having one or less primary alcohol groups.

2. The ink composition of claim 1, wherein said organic solvent is a C₄-C₆ polyhydric alcohol having no primary alcohol groups.

3. The ink composition of claim 2, wherein said C₄-C₆ polyhydric alcohol having no primary alcohol groups is selected from the group consisting of 2,3-dimethyl-2,3-butanediol, 2,3-butanediol, 2,4-pentanediol, 2,5-hexanediol and hexylene glycol.

4. The ink composition of claim 1, wherein said organic solvent is a C₄-C₆ polyhydric alcohol having one primary alcohol group.

5. The ink composition of claim 4, wherein said C₄-C₆ polyhydric alcohol having one primary alcohol group is selected from the group consisting of 2-methyl-1,2-propanediol, 1,2-butanediol, 1,3-butanediol, 1,2-pentanediol, 1,2-hexanediol and hexane-1,3,5-triol.

6. The ink composition of claim 1, wherein said C₄-C₆ polyhydric alcohol having no primary alcohol groups is hexylene glycol, and said C₄-C₆ polyhydric alcohol having one primary alcohol group is 1,3-butanediol.

7. The ink composition of claim 1, wherein said reactive dye is selected from the group consisting of monochlorotriazinyl, β-sulfatoethylsulfone and vinylsulfone derivative dyes.

8. The ink composition of claim 7, wherein said reactive dye is monochlorotriazinyl derivative dyes.

9. The ink composition of claim 7, wherein said reactive dye is selected from the group consisting of β-sulfatoethylsulfone and vinylsulfone derivative dyes.

10. The ink composition of claim 1, wherein said reactive dye is selected from the group consisting of C.I. Reactive Red 3:1, C.I. Reactive Red 23, C.I. Reactive Red 31, C.I. Reactive Red 24, C.I. Reactive Yellow 80, C.I. Reactive Yellow 95, C.I. Reactive Blue 15, C.I. Reactive Blue 49, C.I. Reactive Blue 176, C.I. Reactive Orange 12, C.I. Reactive Black 8, and C.I. Reactive Black 5.

11. The ink composition of claim 1, wherein said reactive dye is 5-35 wt %, said water is 35-94.9 wt %, and said organic solvent is 0.1-30 wt %.

12. The ink composition of claim 1, wherein said reactive dye is 10-30 wt %, said water is 50-89 wt %, and said organic solvent is 1-20 wt %.

13. The ink composition of claim 1, which further comprises
(d) a non-ionic surfactant.

14. The ink composition of claim 13, wherein said non-ionic surfactant is an acetylene glycol derivative of the following formula (II), 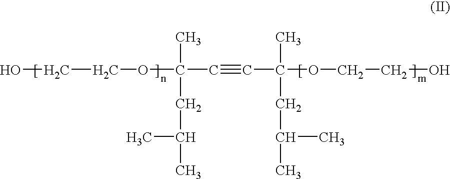
wherein the sum of n and m is an integer ranging from 0 to 50.

15. The ink composition of claim 14, wherein the sum of n and m is an integer ranging from 0 to 20.

16. The ink composition of claim 13, wherein said non-ionic surfactant is 0.1-3 wt %.

17. The ink composition of claim 1, which further comprises (e) a buffer.

18. The ink composition of claim 17, wherein said buffer is 0.1-3 wt %.

19. The ink composition of claim 1, which further comprises (f) a microbicide.

20. The ink composition of claim 19, wherein said microbicide is 0.01-1 wt %.

21. A method for ink-jet printing on material containing cellulose fibers, which comprises using an ink composition of claim 1 to process said material containing cellulose fibers.

22. The method of claim 21 wherein said material containing cellulose fibers is cotton.
